(19) United States
(12) Patent Application Publication
(10) Pub. No.: US 2020/0369538 A1
(43) Pub. Date: Nov. 26, 2020

(54) Copper Foam for Water Purification

(71) Applicant: CellMobility, Inc., Berkeley, CA (US)

(72) Inventors: Hyeji Park, Seoul (KR); Junhyeong Park, Gyeonggi-do (KR); Kendrick Hanjun Rhee, Danville, CA (US); Heeman Choe, Walnut Creek, CA (US)

(21) Appl. No.: 16/880,941

(22) Filed: May 21, 2020

Related U.S. Application Data
(60) Provisional application No. 62/851,002, filed on May 21, 2019.

(51) Int. Cl. C02F 1/50; B01D 39/20; C02F 1/00

(52) U.S. Cl. CPC C02F 1/505; B01D 39/2051; C02F 1/001; C02F 2303/04; B01D 2239/10; B01D 2239/1216; B01D 2239/1208

(57) ABSTRACT

A metal foam, such as copper metal foam, is used for water filtration and purification. A method is used to manufacture a new water purification device with the capability of killing bacteria and viruses using three dimensionally connected copper foam filter consisting of random or elongated channel pores and large surface area, thereby increasing the copper surface area in contact with contaminated water drops and purifying them. The copper foam water filter has pores on the order of several to tens of micrometers and porosity ranging from 50 percent to 75 percent to properly control the water filtration time and the contact time between the copper foam pore surface and water drops during filtration.

### CROSS-REFERENCE TO RELATED APPLICATIONS

This patent application claims the benefit of U.S. patent application 62/851,002, filed May 21, 2019, which is incorporated by reference along with all other references cited in this application.

### BACKGROUND OF THE INVENTION

This invention relates to water filtration and purification, and more specifically to a technique of using a metal foam material with enhanced pore surface area such as copper metal foam for water filtration and purification, especially copper can kill bacteria and viruses.

Despite several technological advances and impressive new discoveries in the twenty-first century, it is a surprising fact that the lack of access to clean water is still a prevalent issue in numerous developing countries. Water related problems such as contaminated drinking water and natural scarcity of drinking water have resulted in the death of over 2 million children each year in countries such as India, Africa, China and many more.

A current technology uses ultraviolet (UV) filters to kill bacteria and viruses contained in contaminated water by applying electromagnetic radiation. Although the UV device is chemical free and can kill bacteria up to 99.99 percent its installation cost is expensive.

There is a need for improved techniques for water filtration and purification, especially by the use of a relatively inexpensive metal foam, such as copper metal foam, as a filtering material.

### BRIEF SUMMARY OF THE INVENTION

A metal foam, such as copper metal foam, is used for water filtration and purification. A copper metal foam water filter can kill bacteria and viruses in contaminated water, as copper has been positively identified to eradicate harmful pathogens, viruses (e.g., the coronavirus including SARS, MERS, and COVID-19) and microbacteria that are contained in polluted water. Copper foam can be placed into the spout of any water purification device, thus allowing an additional method of water purification and bacteria killing in addition to another preexisting water purification device. Copper foam treatment can be used in conjunction with for example, granular activated carbon, reverse osmosis, alkaline filtering, and other techniques.

Not only is copper foam treatment an effective method of water purification, but also more importantly the copper foam is a relatively inexpensive material that can be produced with relative ease in large mass quantities. With over one billion people in developing countries that have inadequate access to a clean and fresh water supply, this low-cost metal foam water filter technology can provide an overwhelmingly positive impact in developing countries that are in a direct need of clean water. Therefore, there is a great demand and need of a metal-foam filter technology for water purification devices, especially for smaller establishments in developing countries owing to its affordability.

A method is used to manufacture a new water purification device with the capability of killing bacteria and viruses using three dimensionally connected copper foam filter consisting of random or elongated channel pores and large surface area, thereby increasing the copper surface area in contact with contaminated water drops and purifying them. The copper foam water filter has pores on the order of several to tens of micrometers and porosity ranging from 50 percent to 75 percent to properly control the water filtration time and the contact time between the copper foam pore surface and water drops during filtration.

In an implementation, a device includes a metal-foam filter material with pore surfaces that make contact with contaminated water drops to kill bacteria and viruses in contaminated water during filtration. The metal-foam filter material can replace or is used in combination with another filter (e.g., traditional filter) such as an activated carbon filter, reverse osmosis filter, ultraviolet filter, or others, and in any combination.

The metal-foam filter material can include at least one of copper foam, copper-tin alloy foam, copper-zinc alloy foam, copper-nickel alloy foam, copper-silicon alloy foam, copper-aluminum alloy foam, silver foam, iron foam, aluminum foam, or titanium foam. The metal-foam filter material can be a copper foam, which is placed before or after the traditional filter such as an activated carbon filter so that bacteria and viruses in contaminated water can be first removed by use of the copper foam filter and then the treated water can be further cleaned by use of the traditional filter. The metal-foam filter can have a porosity between about 50 percent and about 75 percent and pore size ranging from about 0.1 microns to about 100 microns.

A manufacturing process to form the porous metal-foam filter material can include at least one of freeze casting, space holder, or dealloying. The manufacturing process to form the porous metal-foam filter material can include a freeze casting method including a powder slurry freezing or drying and reduction or sintering processes, where the water- or camphene-based powder slurry is frozen and dried at a relatively low temperature between about −10 degrees Celsius and about −80 degrees Celsius to form a green body and then reduced or sintered at a relatively high temperature to form a three dimensionally connected solid porous structure. The reduction can occur at a temperature between about 200 degrees Celsius and about −350 degrees Celsius. The sintering can occur at a temperature between about 700 degrees Celsius and about −1100 degrees Celsius.

Topper oxide powder can be mixed in water or camphene in a volume fraction of between about 8 volume percent and about 22 volume percent following the additions of a binder and a dispersant. A titanium powder is mixed in water or camphene in a volume fraction of between about 10 volume percent and 30 volume percent following the additions of a binder and a dispersant.

A metal-foam filter material can be a titanium foam with a titanium dioxide coating grown on its pore surface, which kills bacteria and viruses in combined use with visible or ultraviolet light.

In an implementation, a method includes: connecting a water source inlet to a first filter; connecting an outlet of the first filter to a second filter, where at least one of the first filter or the second filter has a metal foam material; conducting water to be treated from the water source inlet to the first filter, through the first filter, to the second filter, through the second filter; and providing treated water at an outlet of the second filter.

The metal foam material can be a copper foam having a porosity from about 50 percent to about 75 percent. The copper foam can have a thickness of 7 millimeters or greater. In other implementations, the copper foam has a thickness of 1, 2, 3, 4, 5, or 6 millimeters or greater.

The copper foam can have a pore size of less than about 40 microns. In other implementations, the copper foam has a pore size of 50, 45, 40, 38, 35, 34, 30, 28, 25, 23, 20, 18, 10, of 5 microns or less. The copper foam can have a strut size of about 10 microns or less. In other implementations, the copper foam has a strut size of 30, 25, 20, 16, 10, 8, 7, 6, 5, 4, 3, or 2 microns or less.

In an implementation, a method includes: connecting a water source inlet to a first filter; coupling an outlet of the first filter to a second filter, where at least one of the first filter or the second filter has a metal foam material, the metal foam material includes a copper foam having a porosity from about 50 percent to about 75 percent, the copper foam has a thickness of 7 millimeters or greater, the copper foam has a strut size of about 10 microns or less; conducting water to be treated from the water source inlet to the first filter, through the first filter, to the second filter, through the second filter; and providing treated water at an outlet of the second filter.

The first filter can include activated carbon while the second filter includes the copper foam. The first filter can include a reverse osmosis filter while the second filter includes the copper foam.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 shows a block diagram of general principles of water filters.

FIG. 2 shows the use of an activated carbon filter to filter water.

FIG. 3 shows use of a reverse osmosis filter to filter water.

FIG. 4 shows use of an alkaline ionizer or water ionizer to filter water.

FIG. 5 shows use of an ultraviolet filter to filter water.

FIG. 6 shows use of a distillation filter to filter water.

FIG. 7 shows a technique of using copper foam for water filtration.

FIG. 8 shows a contaminated water drop that sits on top of a copper foam material.

FIGS. 9A and 9B shows sequences of water passing through a copper foam filter.

FIGS. 10A and 10B show magnified cross-sectional views of the copper foam material used for water filtration.

FIG. 11 shows a block diagram for a point-of-use water filtration system or device, including a metal foam filter material.

### DETAILED DESCRIPTION OF THE INVENTION

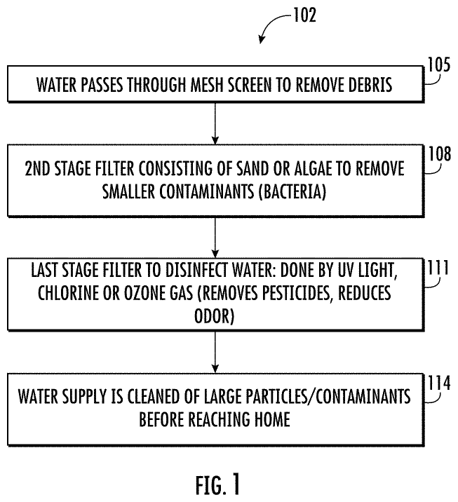

FIG. 1 shows a flow diagram of general principles of water filters. Each of the blocks in a flow 102 represents stages of a municipal water treatment system or large treatment plant.

In a stage 105, water passes through a mesh screen to remove debris.

In a stage 108, a second stage filter consisting of sand, algae, or other filtering media is used to remove smaller contaminants, such as bacteria.

In a stage 111, a third stage filter (which can be a final or last stage) is used to disinfect water. This can be done by ultraviolet (UV) light, radiation, or chorine or ozone gas, or other disinfectant or disinfecting process can be used. This stage can remove pesticides and remove odors.

In a stage 114, after having passes through the treatment stages, the water supply is cleaned of relatively large particles and contaminants. Then, the treated water can be delivered to businesses, homes, and other water consumers.

The second stage removes bacteria physically. The third stage removes bacteria electromagnetically. A simpler and more effective water filter technology is desirable for bacteria and viruses removal.

However, just because treated water reaches the homes of a municipality does not mean water is 100 percent pure or clean. Some external factors (e.g., aged plumbing) that still can cause water to be contaminated with microorganisms in the pipe. Some examples include aged pipes and leaking sewage water. With aged pipes, heavy metal can leak or leach into the water supply. This is why it is still important to use filters at the tap or faucet (e.g., home, office, or water fountain filters).

An example of a point-of-use filter is a granular activated carbon (GAC) filter. The granular activated carbon filter is relatively cheap and effective due to its large surface area, but cannot eliminate bacteria and viruses.

Granular activated carbon filters are popular. This is because a small amount of carbon has large surface area; 1 gram per GAC=32,000 square feet; and popular carbon powder size range: 20×40 carbon (85 percent passing). With granular activated carbon filters, more contaminants can be filtered out. Some examples include heavy metals (e.g., lead, mercury). Average contaminant size filter is about 3.5 grams per cubic centimeter to about 7 grams per cubic centimeter. Also, granular activated carbon filters leave positive mineral ions that are beneficial to the body such as fluoride, calcium, and magnesium.

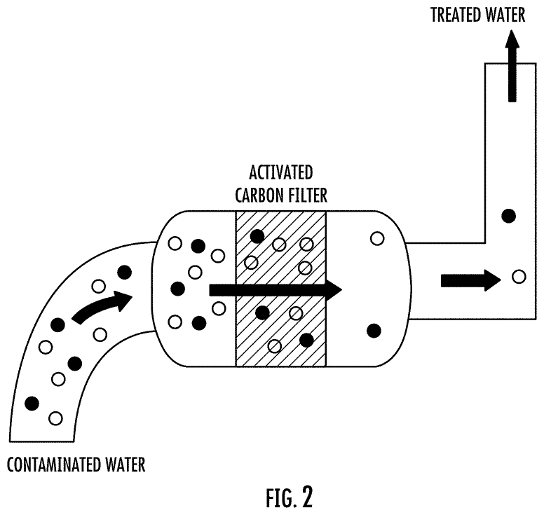

FIG. 2 shows the use of an activated carbon filter to filter water. Contaminated water is input to the activated carbon filter, and treated water is output from the activated carbon filter. An activated carbon filter is easy to use. But generally the lifetime of an activated carbon filter is relatively short. They are also not good at removing chemicals.

There are advantages and disadvantages of activated carbon (AC) filters. Advantages include: made from natural materials such as wood, bituminous, coconut oil; low cost and easy maintenance; enhance water taste and odor; and good at filtering out chemical disinfectants like chlorine, bromine, and others. Disadvantages include: relatively short service life; activated carbon filters need to be replaced to be effective; and not good at removing chemicals not attracted to carbon (e.g., sodium and nitrates).

Activated carbon filters are mainly used by residential household. Replacement periods or life cycles are recommended from about 6-12 months, when water changes color, odor, and taste. Failure to replace may result in lower water quality or bacteria overgrowth, or both.

A process flow of an activated carbon filter includes:

1. Contaminated water first enters the activated carbon filter.

2. Absorption Process: When both organic and chemical particles are trapped inside the activated carbon filter.

3. Activated carbon filters tend to work best for removing organic chemical with larger molecules.

4. Factors that affect activated carbon filters performance is molecular weight: higher molecular weight allows the activated carbon to absorb more effectively because molecules are less soluble in water.

5. Physical Filtering: removes small particle (e.g., sand, man-made or synthetic chemicals that come in contact with tap water).

6. Chemical Removal: some examples include hydrogen sulfide, chlorine, benzene, and radon, and others. Chemical filtering and physical filtering are both important because these two stages are needed to obtain the purest or cleanest water possible.

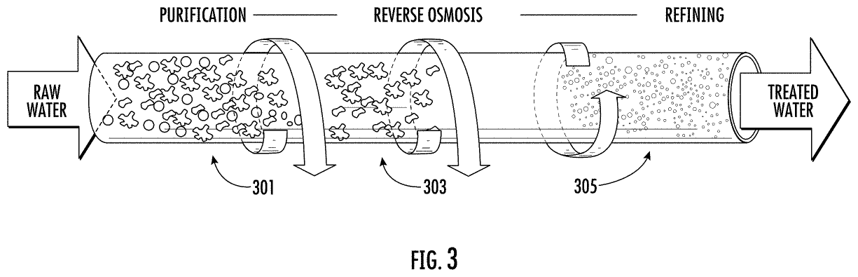

FIG. 3 shows use of a reverse osmosis filter to filter water. At a stage 301, algae, plankton, suspended solids, colloids, pathogens, and macro-molecules are filtered. At a stage 303, smaller solids and salts are filtered. At a stage 305, minerals are filtered. Reverse osmosis (RO) filters are mainly used by residential households. Replacement periods/life cycles are recommended from about 6-12 months. Timely filter changes are important for reverse osmosis filters.

Some advantages of reverse osmosis filters include: improves water taste, odor, and appearance; saves money long term (e.g., cancelling water delivery and buying water bottles); and energy efficient. Some disadvantages can include: can get easily clogged if not properly maintained; annual filter replacements can be (typically relatively costly); and filtering is a time-consuming process.

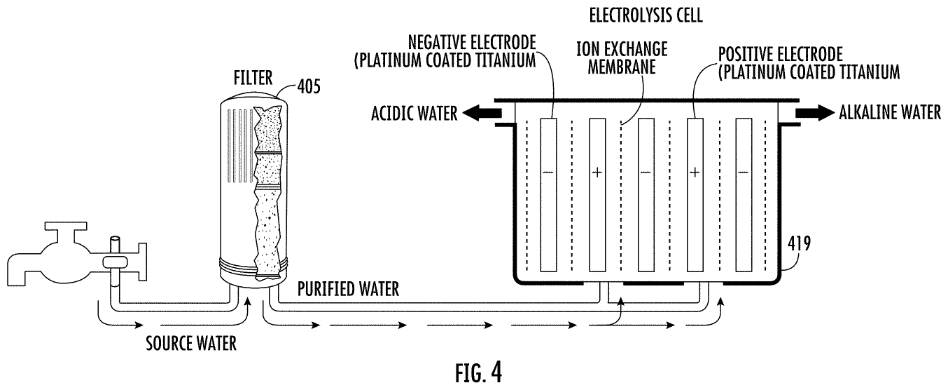

FIG. 4 shows use of an alkaline ionizer or water ionizer to filter water. Source water is input an initial filter 405 of the alkaline ionizer or water ionizer process. Purified water is output from the filter. This purified water is input to an electrolysis cell 419. In the electrolysis cell, there are negative electrodes (e.g., platinum coated titanium), ion exchange member, and positive electrodes (e.g., platinum coated titanium), and two output ports, one for acidic water and one for alkaline water. The alkaline water can be used as the filtered water.

Alkaline or water ionizers are mainly used by residential households. Replacement periods or life cycles are recommended to be about every 8 months or about every 1000 gallons. An automatic cleaning feature is recommended because chemicals in tap water can cause scaling and corrosion.

Some advantages of alkaline or water ionizers include: alkaline water has good antioxidant properties; can provide better level of hydration; and can help reduce acid reflux and heartburn. Some disadvantages can include: very expensive relatively, such as from $100 to $5000; and not a popular form of filter.

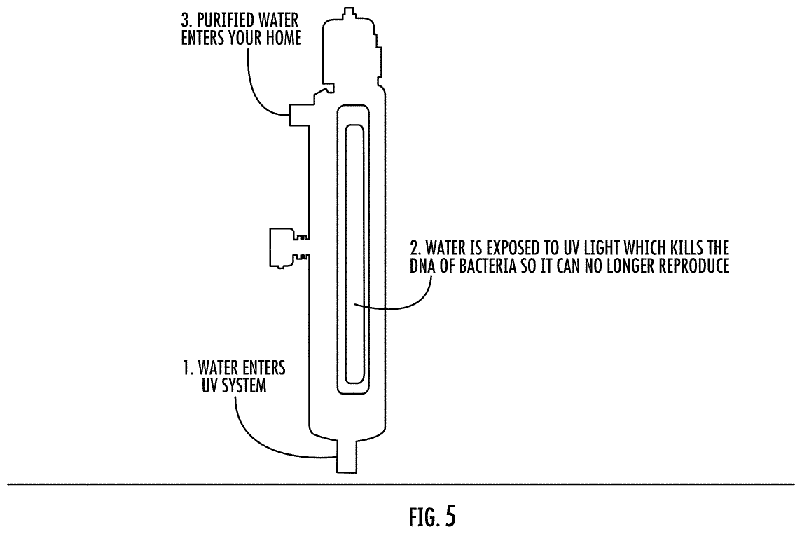

FIG. 5 shows use of an ultraviolet filter to filter water. Electromagnetic radiation is used to decontaminate water to be treated. Water enters an ultraviolet filter input port. The water is exposed to ultraviolet light, which kills the DNA of bacteria so that it can no longer reproduce. Purified water exits an output port of the ultraviolet filter. An ultraviolet light filter is one of the most common filters for killing bacteria in contaminated water, despite their expensive cost.

Ultraviolet water filters are mainly used by residential households and large treatment plants. A recommended replacement period or life cycle for the ultraviolet light bulb is about every 12 months or about 9000 hours of operation. A recommended replacement period or life cycle for ultraviolet quartz sleeve is about every 2-3 years.

Ultraviolet light filtering is a physical process, not a chemical process. A process filter water using ultraviolet light includes:

1. Ultraviolet light shines on contaminated water for purification process.

2. Frequency used in killing microorganisms is a wavelength of about 254 nanometers.

3. Ultraviolet light dose of 40 millijoules per cubic centimeter, which is a minimum ultraviolet light dose applied to water.

4. As water is exposed to ultraviolet light, it attacks genetic code of bacteria DNA or RNA and kills the bacteria.

5. Microorganisms can no longer reproduce due to their exposure to ultraviolet light.

Some water pretreatment prerequisites include: turbidity or haze of less than 1 nephelometric turbidity unit (NTU); suspended solids of less than about 10 milligrams per liter; no color; total iron of less than about 0.3 milligrams per liter; manganese of less than about 0.05 milligrams per liter; hardness of less than about 7 grains per gallon. A quartz glass sleeve is designed to keep a temperature at approximately 104 degrees Fahrenheit.

Some advantages of ultraviolet filters include: kills 99.99 percent of harmful bacteria, chemical free; low energy use; and relatively easy to install. Disadvantages can include: cannot remove salts, heavy metals, chlorine; relatively expensive (e.g., average $1500); and long filtration process: (1) Sediment prefiltering (ensures water is clear for UV light disinfection); (2) activated carbon filter for improved water taste; and (3) enters stainless steel chamber with purifying ultraviolet light.

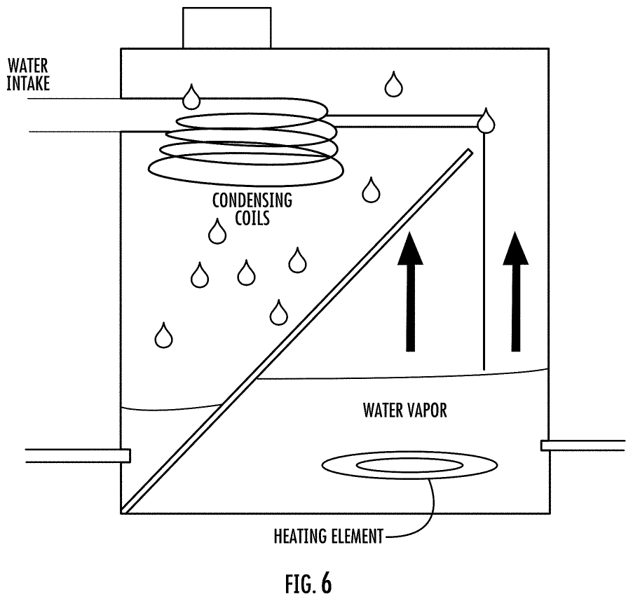

FIG. 6 shows use of a distillation filter to filter water. In a distillation filter, water is heated using a heating element to boiling temperature to kill microbes such as bacteria, cysts, and viruses that may be present. Steam or water vapor is produced and rises, leaving behind dead microbes, dissolved solids, salts, heavy metals, and other substances. This steam vapor is condensed using condensing coils, which may be cooled using water from a water intake. Then cooled water (e.g., droplets) is produced, which will be the distilled water.

Distillation filters are mainly used by residential households. They may be the least common form of filter due to a relatively time-consuming filtering process. Distillation filters can also kill bacteria and viruses by consuming considerable electricity during filtering process. As for replacement periods or life cycles, it is generally recommended to change filters about every 6 months with normal usage, heating element cleaned about every 3-6 months depending on amount of water made and to prevent water scale build up.

Advantages distillation filters include: bacteria and viruses are killed when water evaporates; removes salt, minerals, metals that carbon filter fails to remove; and nothing to be replaced. Disadvantages can include: long hours to obtain water (e.g., 30 minutes for 1 cup); lots of electricity used; and water cannot be distilled without considerable electricity, which is not practical during emergencies.

Water Filter User Market. For activated carbon filters, they are typically used by homes, restaurants, schools, and hotels. For reverse osmosis filters, they are typically used by homes, restaurants, schools, military bases, hotels, RVs, and hospitals. For alkaline filters, they are typically used by homes, private gyms, workplaces or offices, and private spas. For UV filters, they are typically used by hospitals, restaurants, workplaces or offices, and large treatment plants. For distillation filters, they are typically used by homes and science/research labs. The most popular water filtration systems are activated carbon filters and reverse osmosis filters.

Some examples of filters include pitcher filters that use carbon filtering, ranging in price from about 15 dollars to about 50 dollars. Reverse osmosis filters range in price from about 150 dollars to about 400 dollars. Alkaline water ionizer filters range in price from about 400 dollars to about 3000 dollars. Ultraviolet filters range in price from about 300 dollars to about 5000 dollars. Distillation filters range in price from about 100 dollars to about 500 dollars. All of these commonly available water filters cost from several tens to a few thousand dollars. The cost of a metal-foam water filter as described in this patent is comparable to or lower than those of these water filters.

List of top countries with the most polluted water supply:

1. India, where only 6 percent of the population has access to clean water and 75.8 million are without safe drinking water.

2. Nigeria, where 63 million people are without access to clean water and 45 thousand children under the age of 5 die due to diarrhea from unsafe water.

3. Congo, where 50 million people are without access to clean water, 70 percent of the rural population lacks access to clean water, and 71 percent of the rural population lacks safe sanitation in general.

4. China, where water pollutants are released due to industrial activity, 80 percent of water from wells are not safe to drink, and 60 percent of ground water is of extremely poor quality.

5. Ethiopia, where 42 million people are without access to clean water, and 71 million are without access to safe sanitation.

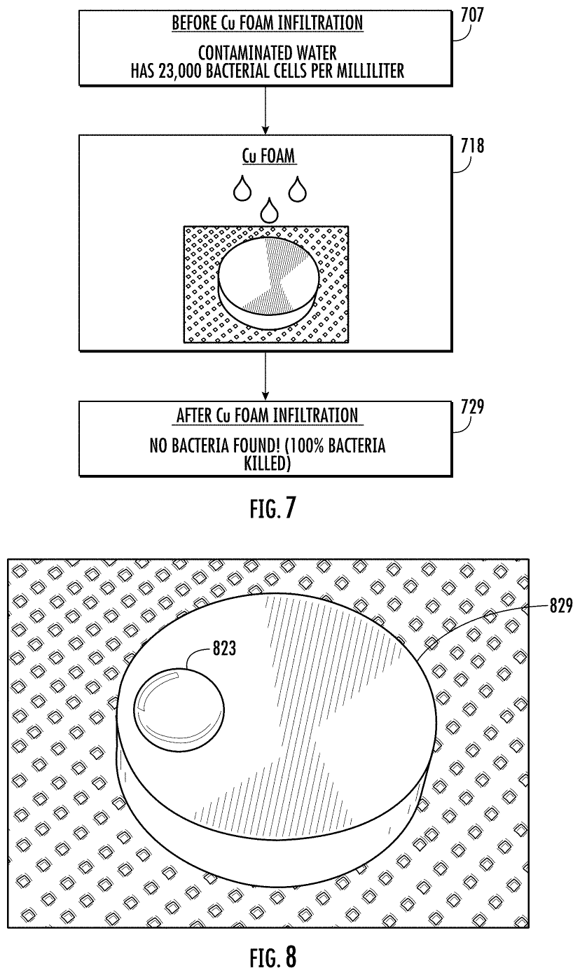

FIG. 7 shows a technique of using copper foam for water filtration. Untreated water 707 (e.g., contaminated water) is input to a filter including a copper foam material 718. An output of the copper foam material filter is treated water 729 (e.g., uncontaminated or clean water).

Copper foam can kill 100 percent of bacteria in water. In testing, contaminated water with 23,000 CFU per milliliter (e.g., 23,000 bacterial cells per milliliter) was passed through a copper foam filter. After the contaminated water was passed through the copper foam filter, no bacteria was found in the water—100 percent of bacteria was killed.

Access to clean water is the norm to United States of America and Europe but in developing countries, waterborne infections are common. The top three most prevalent bacterial gastrointestinal diseases transmitted through contaminated water are cholera, salmonella, and shigella. There is an urgent need for the development of an affordable bacteria-killer water filter.

About 2.5 billion people have no access to improved water sanitation. According to World Health Organization, the mortality rate of water related diseases is about 5 million people per year. As of 2018, cholera is the most common microbial intestinal infection. Without treatment, cholera mortality rate is about 50 percent. Cholera, salmonella, and shigella are transmitted via unsanitary or contaminated water. Salmonella can spread from undercooked or raw food. Shigella can spread from direct contact with infected person. One can reduce the risk for these bacterial infections by improving water purification devices for all—regardless of income, age, or demographic.

When using a copper foam filter for purification, copper oxide, known as patina, does not easily fall off to be absorbed in human body through drinking water. According to a Japanese study conducted in 1982, the patina does not melt away or dissolve even in hot water.

Copper oxide, known as patina, is not harmful to the human body. The surface of the patina includes dense crystals and is formed on the surface of copper like a skin that protects the human body. According to studies, the lifetime of copper pipes is estimated to be about 20 years. Therefore, if you reduce the copper foam replacement cycle to several years. There is no problem at all, as already the case with copper plumbing.

The copper oxide (patina) can be easily removed by using citric acid, salt, vinegar, and others, which is commonly available.

FIG. 8 shows a contaminated water drop 823 that sits on top of a copper foam material 829. The copper foam material can have a cylindrical shape, but any other geometric solid shapes may be fabricated (e.g., cube, rectangular prism, triangular prism, sphere, pyramid, cone, torus, polyhedra solids, nonpolyhedra solids, and others). The water will go through the pores or porous surface of the copper foam sample, making contact with the three-dimensional copper foam surfaces as the water passes through, which will result in the killing of bacteria contained in the water.

Typically, filters range in price from about 10 dollars to about 5000 dollars. In comparison, a copper foam filter can be about 5 dollars or less, depending on the scale of manufacturing. Some additional advantages of a copper foam filter include: copper is 100 percent recyclable (resulting in even lower manufacturing cost). Copper oxide is known to cause no harm to human body.

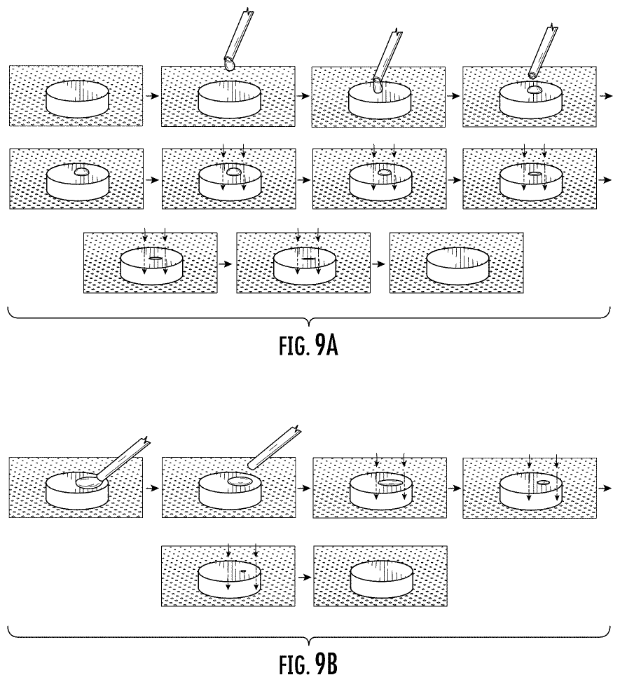

FIG. 9A shows a sequence of figures where contaminated water is dropped on a first side (e.g., top side) of a copper foam material and then slowly gets absorbed by the copper foam material, passing through to the other side of the material. FIG. 9B shows a similar sequence of figures, but for water dropped from a second side (opposite to the first side, e.g., bottom side). This copper foam filter is dual sided and can operate by filtering water from the first side to the second side, or from the second side to the first side. After passing through the copper foam material, the water will have been purified or treated (e.g., cleaned of bacteria and viruses).

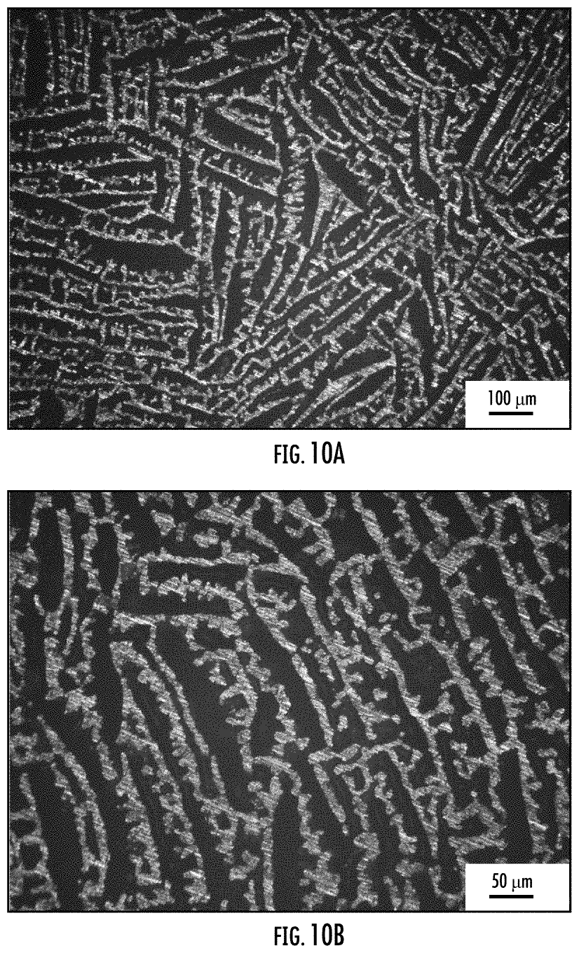

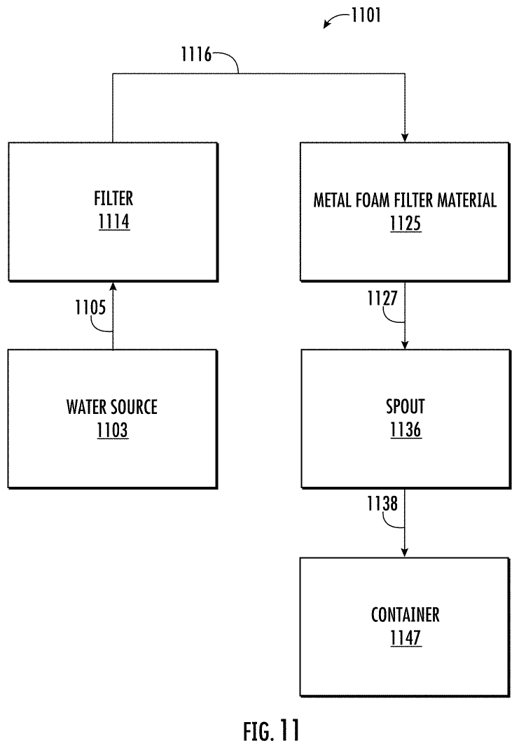

FIGS. 10A and 10B show magnified cross-sectional views of the copper foam material used for water filtration. For these figures, dimensions of the cylindrical copper foam material are: diameter of 26 millimeters, thickness of 7 millimeters, strut size of about 10 microns, pore size of less than about 40 microns, and a porosity of about 70.7 percent.

This patent describes some examples of implementations with specific dimensions, measurements, and values. These are not intended to be exhaustive or to limit the invention to the precise form described. The values, percentages, times, and temperatures are approximate values. These values can vary due to, for example, measurement of manufacturing variations or starting powder chemistry or tolerances or other factors. For example, depending on the tightness of the manufacturing and measurement tolerances, the values can vary plus or minus 5 percent, plus or minus 10 percent, plus or minus 15 percent, or plus or minus 20 percent.

Further, the values are for a specific implementation, and other implementations can have different values, such as certain values made larger for a larger-scaled sized process or product, or smaller for a smaller-scaled product. A device, apparatus, or process may be made proportionally larger or smaller by adjusting relative measurements proportionally (e.g., maintaining the same or about the same ratio between different measurements). In various implementations, the values can be the same as the value given, about the same of the value given, at least or greater than the value given, or can be at most or less than the value given, a range within or outside of any values presented, or any combination of these.

Some techniques or flows are described. A flow may have additional steps (not necessarily described in this patent), different steps which replace some of the steps presented, fewer steps or a subset of the steps presented, or steps in a different order than presented, or any combination of these. Further, the steps in other implementations may not be exactly the same as the steps presented and may be modified or altered as appropriate for a particular application or based on the situation.

In an embodiment, manufacture of a copper foam water filter includes:

1. Copper powder slurry, which consists of about 14 volume percent copper oxide powder and about 2.5 weight percent polyvinyl alcohol (PVA) binder, was created by mixing with about 30 milliliters deionized water.

2. The slurry was well dissolved in the solution by using stirring and sonication.

3. The slurry was then poured into a silicone mold placed on the chilled copper rod. The temperature of the top of the copper rod was fixed at about −30 degrees Celsius by using liquid nitrogen and maintained at the temperature by using a controller.

4. After the slurry was completely frozen, it was sublimated at about −80 degrees Celsius for about 40 hours in a freeze-dryer in vacuum, resulting in removal of the ice crystals and leaving a green-body with directional pores.

5. The green-body was then reduced from copper oxide to pure copper in hydrogen atmosphere and was subsequently sintered at higher temperature.

6. Reduction and sintering processes consists of the presintering at about 250 degrees Celsius for about 4 hours and the actual sintering at about 800 degrees Celsius for about 14 hours in a tube furnace under hydrogen mixture gas to result in a copper foam with about 63 percent porosity.

7. The manufactured copper foam sample is then cut or milled into the form of a desired shape (e.g., cylindrical shape) to replace a traditional water filter such as an activated carbon filter or be used in conjunction with it.

U.S. patent applications 62/194,564, filed Jul. 20, 2015, Ser. No. 15/215,519, filed Jul. 20, 2016, 62/194,677, filed Jul. 20, 2015, Ser. No. 15/215,541, filed Jul. 20, 2016, 62/641,223, filed Mar. 9, 2018, PCT/US2019/021704, filed Mar. 11, 2019, 61/700,793, filed Jul. 19, 2018, and PCT/US2019/042686, filed Jul. 19, 2019 are incorporated by reference. These applications describe techniques of manufacturing a metal foam, such as a copper metal foam. These techniques, in whole or in part, can be used to manufacture a metal foam that is used for water treatment or filtration.

There are differences between metal foams used for water filtration as compared to other applications. For water filtration, a volume percent of the copper powder in the starting slurry is greater than for other applications. This is to achieve a final porosity that is lower (e.g., about 50 percent to about 75 percent) than those used in other applications. This is to allow the water drops flow through copper foam slowly enough that sufficient contact time is achieved between the water drops and copper foam pore surface to kill bacteria and viruses.

Although copper foam has been given as an example of a metal foam for water treatment. Other metal foams can also be used. Some examples include silver foam, alloys of copper, and titanium with a titanium oxide coating on its surface. For titanium with a titanium oxide coating, this would work together with visible light to destroy bacteria and viruses.

FIG. 11 shows a block diagram for a point-of-use water filtration system or device 1101, including a metal foam filter material. Point-of-use water filtration systems are to be used right where a person uses the water such as in the shower, bath, kitchen, washing machine, faucet, or water bottle. Point-of-use filters are a final stage of purification before the water is dispensed from the water supply. These are in contrast to point-of-entry water filters purify water for your entire location (e.g., house or office building). Metal foam filtration can also be used as point-of-use filters as well as point-of-entry filters.

Most users install these point-of-use systems to filter water that they will be using for drinking, cooking, bathing, washing hands, washing clothes, or washing dishes. Some examples of point-of-use filtration systems or devices include water filter pitchers, under-sink water filters, faucet-mounted water filters, and countertop water filters.

There is no one single process that can ensure 100 percent removal of potential risk through secondary disinfection. So a multilevel approach can be used to ensure water security all the way to the point of use. Even with filtration at the point-of-entry and secondary purification installed within the water distribution system, substantial risk still remains at the point-of-use. Point-of-use filtration is a final barrier to prevent harmful pathogens from coming in contact with users, and is particularly important for protecting those who are immunocompromised or immunosuppressed.

Referring to FIG. 11, the system or device has a water source 1103. The water source can be a vessel or container, such as in the case of a water pitcher filter type. Or the water source or inlet can be a water supply pipe or plumbing, which can have a valve to connect or disconnect the water supply to the system. The water source can be at room temperature, heated, or cooled or refrigerated.

The water source is connected via a connection 1105 to a filter 1114. Connection 1105 can be a pipe, plumbing, tubing, line, channel, pump, siphon, or another physical connection or technique to move water from the water source to the filter.

The filter is a first stage of the water filtration of this point-of-use water filtration system. The first filter can use one or a combination of filtration technology described above (not metal foam), such as an activated carbon filter, reverse osmosis filter, ion exchange filter, mechanical filter, or chemical filter, or combination of these. The

The filter is connected via a connection 1116 to a metal foam filter material 1125. Connection 1116 is similar to connection 1105 described above and can be a physical connection or technique to move water from the water filter to the metal foam filter material, which is a second stage of the water filtration.

The metal foam filter material can be a copper metal foam or other metal foam such as titanium metal foam, platinum metal foam, tin metal foam, aluminum metal foam, or a combination of these or and alloy of various metals. The water enters an input side of the metal foam filter, passes through the porous metal material, and exits an output side (or outlet) of the metal foam filter (which is typically on an opposite side of the input side). Once the water reaches the output side of the metal foam filter material, the water has been cleaned of bacteria and viruses.

The water can be conducted to the metal foam filter by gravity, such as a person tilting a water filter pitcher to pour water. For example, the person can raise the water level above a height of the filter, and water follows gravity (which creates water pressure) through the connection to the water filter and through the water filter.

Instead of gravity, the water can be conducted to the metal foam filter by water pressure, such as from a pump or water pressure in water supply line. This water pressure pushes the water through to the water filter and through the water filter. When water pressure is available, then instead of the water path being from up to down through the metal foam as for a gravity feed system, the water path can be in any direction, left to right, right to left, and even from down to up (e.g., opposite of gravity).

The metal foam filter is connected via a connection 1127 to a spout 1136, which is an output of the point-of-use water filtration system or device. Connection 1127 can be similar to connections 1105 and 1116 described above and can be a physical connection or technique to move water from the metal foam filter to the spout.

From the spout, the water can be poured or directed 1138 into a container 1147, such as a cup or pot for drinking or cooking. Or the water can be used for washing water in a sink or shower. In an implementation, the metal foam filter is incorporated into the spout. Also in another implementation, metal foam filter 1125 is before filter 1114 instead of after. Then the metal foam filter would be the first stage and the other filter (e.g., filter 1114) would be the second stage.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A device comprising:
a metal-foam filter material with pore surfaces that make contact with contaminated water drops to kill bacteria and viruses in contaminated water during filtration.

2. The device of claim 1 wherein the metal-foam filter material replaces or is used in combination with a traditional filter such as an activated carbon filter, reverse osmosis filter, or ultraviolet filter.

3. The device of claim 1 wherein the metal-foam filter material comprises at least one of copper foam, copper-tin alloy foam, copper-zinc alloy foam, copper-nickel alloy foam, copper-silicon alloy foam, copper-aluminum alloy foam, silver foam, iron foam, aluminum foam, or titanium foam.

4. The device of claim 2 wherein the metal-foam filter material is copper foam, which is placed before or after a traditional filter such as an activated carbon filter so that bacteria and viruses in contaminated water can be first removed by use of the copper foam filter and then the treated water can be further cleaned by use of the traditional filter.

5. The device of claim 3 wherein the metal-foam filter has porosity between about 50 percent and about 75 percent and pore size ranging from about 0.1 microns to about 100 microns.

6. The device of claim 1 wherein a manufacturing process to form the porous metal-foam filter material comprises at least one of freeze casting, space holder, or dealloying.

7. The device of claim 1 wherein a manufacturing process to form the porous metal-foam filter material comprises a freeze casting method including a powder slurry freezing or drying and reduction or sintering processes, where the water- or camphene-based powder slurry is frozen and dried at a relatively low temperature between about −10 degrees Celsius and about −80 degrees Celsius to form a green body and then reduced or sintered at a relatively high temperature to form a three dimensionally connected solid porous structure.

8. The device of claim 7 wherein the reduction occurs at a temperature between about −200 degrees Celsius and about −350 degrees Celsius.

9. The device of claim 7 wherein the sintering occurs at a temperature between about −700 degrees Celsius and about −1100 degrees Celsius.

10. The device of claim 7 wherein copper oxide powder is mixed in water or camphene in a volume fraction of between about 8 volume percent and about 22 volume percent following the additions of a binder and a dispersant.

11. The device of claim 7 wherein a titanium powder is mixed in water or camphene in a volume fraction of between about 10 volume percent and 30 volume percent following the additions of a binder and a dispersant.

12. The device of claim 1 wherein the metal-foam filter material is a titanium foam with a titanium dioxide coating grown on a pore surface, which kills bacteria and viruses in combined use with visible or ultraviolet light.

13. A method comprising:
coupling a water source inlet to a first filter;
coupling an outlet of the first filter to a second filter, wherein at least one of the first filter or the second filter comprises a metal foam material;
conducting water to be treated from the water source inlet to the first filter, through the first filter, to the second filter, through the second filter; and
providing treated water at an outlet of the second filter.

14. The method of claim 13 wherein the metal foam material comprises a copper foam comprising a porosity from about 50 percent to about 75 percent.

15. The method of claim 14 wherein the copper foam comprises a thickness of 7 millimeters or greater.

16. The method of claim 14 wherein the copper foam comprises a pore size of less than about 40 microns.

17. The method of claim 14 wherein the copper foam comprises a strut size of about 10 microns or less.

18. A method comprising:
coupling a water source inlet to a first filter;
coupling an outlet of the first filter to a second filter, wherein at least one of the first filter or the second filter comprises a metal foam material,
the metal foam material comprises a copper foam comprising a porosity from about 50 percent to about 75 percent,
the copper foam comprises a thickness of 7 millimeters or greater,
the copper foam comprises a strut size of about 10 microns or less;
conducting water to be treated from the water source inlet to the first filter, through the first filter, to the second filter, through the second filter; and
providing treated water at an outlet of the second filter.

19. The method of claim 18 wherein the first filter comprises an activated carbon filter, and the second filter comprises the copper foam.

20. The method of claim 18 wherein the first filter comprises a reverse osmosis filter, and the second filter comprises the copper foam.
